(19) United States
(12) Patent Application Publication
(10) Pub. No.: US 2025/0209264 A1
(43) Pub. Date: Jun. 26, 2025

(54) TEXT PROCESSING METHOD AND APPARATUS, ELECTRONIC DEVICE, AND STORAGE MEDIUM

(71) Applicant: Beijing Youzhuju Network Technology Co., Ltd., Beijing (CN)

(72) Inventors: Xiaoya CHEN, Beijing (CN); Huiying LIN, Beijing (CN); Qiang LU, Beijing (CN); Weicheng FU, Beijing (CN)

(21) Appl. No.: 18/920,816

(22) Filed: Oct. 18, 2024

(30) Foreign Application Priority Data
Dec. 25, 2023 (CN) 202311799624.X

(51) Int. Cl. G06F 40/237; G06F 40/284; G06F 40/58

(52) U.S. Cl. CPC G06F 40/237; G06F 40/284; G06F 40/58

(57) ABSTRACT

A text processing method and apparatus, an electronic device, and a storage medium are provided. The text processing method includes: obtaining a first text to be processed; determining a target keyword based on the first text; displaying a first graphical user interface, displaying the first text in a first display region of the first graphical user interface, and displaying the target keyword in a second display region of the first graphical user interface; and importing the target keyword currently displayed in the second display region into a target lexicon.

### CROSS-REFERENCE TO RELATED APPLICATION

This application claims the priority of Chinese Patent Application No. 202311799624.X filed on Dec. 25, 2023, the disclosure of which is incorporated by reference herein in its entirety as part of the present application.

### TECHNICAL FIELD

The embodiments of the present disclosure relate to the field of computer technologies, and in particular, to a text processing method and apparatus, an electronic device, and a storage medium.

### BACKGROUND

In a translation preparation stage, a translator usually needs to collect and organize related materials, and find out frequently-used words, professional terms, nouns, and other keywords in the related field, so that recognition and translation of related words are more accurate in subsequent translation. A related translation engine can perform machine translation in combination with a specified lexicon, to improve the accuracy of a machine translation text. However, in many cases, it is necessary to update the lexicon in a personalized and efficient manner.

### SUMMARY

The present summary section is provided to introduce concepts related to the present disclosure in a simplified form, which are further described below in the Detailed Description. This Summary is not intended to identify key features or essential features of the claimed subject matter, nor is it intended to be used to limit the scope of the claimed subject matter.

According to one or more embodiments of the present disclosure, a text processing method is provided, the method includes:
obtaining a first text to be processed;
determining a target keyword based on the first text;
displaying a first graphical user interface, displaying the first text in a first display region of the first graphical user interface, and displaying the target keyword in a second display region of the first graphical user interface; and
importing the target keyword currently displayed in the second display region into a target lexicon.

According to one or more embodiments of the present disclosure, a text processing apparatus is provided, the apparatus includes:
a receiving unit, configured to obtain a first text to be processed;
a determining unit, configured to determine a target keyword based on the first text;
a display unit, configured to display a first graphical user interface, display the first text in a first display region of the first graphical user interface, and display the target keyword in a second display region of the first graphical user interface; and
a storage unit, configured to import the target keyword currently displayed in the second display region into a target lexicon.

According to one or more embodiments of the present disclosure, an electronic device is provided, the electronic device includes: at least one memory and at least one processor, the memory is configured to store a program code, and the processor is configured to call the program code stored in the memory to enable the electronic device to perform the method provided according to one or more embodiments of the present disclosure.

According to one or more embodiments of the present disclosure, a non-transitory computer storage medium is provided, the non-transitory computer storage medium stores a program code, when the program code is executed by a computer device, the computer device is caused to perform the method according to one or more embodiments of the present disclosure.

### BRIEF DESCRIPTION OF DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and components and elements are not necessarily drawn to scale.

FIG. 1 is a flowchart of a text processing method according to an embodiment of the present disclosure;

FIG. 2 is a schematic diagram of a preset interface according to an embodiment of the present disclosure;

FIG. 3A is a schematic diagram of a first graphical user interface according to an embodiment of the present disclosure;

FIG. 3B is a schematic diagram of a first graphical user interface according to another embodiment of the present disclosure;

FIG. 4 is a signal flow diagram of a text processing system according to an embodiment of the present disclosure;

FIG. 5 is a schematic diagram of a text processing apparatus according to an embodiment of the present disclosure; and

FIG. 6 is a structural schematic diagram of an electronic device according to an embodiment of the present disclosure.

### DETAILED DESCRIPTION

Embodiments of the present disclosure are described in detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the protection scope of the present disclosure.

It should be understood that the steps described in the embodiments of the present disclosure may be performed in different orders, and/or performed in parallel. In addition, additional steps may be included and/or the execution of the illustrated steps may be omitted in the implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. The term “in response to” and related terms refer to that one signal or event is affected to a certain extent by another signal or event, but not necessarily completely or directly. If event x occurs “in response to” event y, it means that x may directly or indirectly respond to y. For example, the occurrence of y may ultimately result in the occurrence of x, but there may be other intermediate events and/or conditions. In other cases, y may not necessarily result in the occurrence of x, and x may occur even if y has not occurred. In addition, the term “in response to” may also mean “at least partially in response to”.

The term “determine” encompasses a wide variety of actions, and may include, for example, obtaining, calculating, computing, processing, deriving, investigating, looking up (for example, looking up in a table, a database, or another data structure), ascertaining, and similar actions, and may also include receiving (for example, receiving information), accessing (for example, accessing data in a memory), and similar actions, as well as resolving, selecting, choosing, establishing, and similar actions. Related definitions of other terms will be given in the description below.

It can be understood that data (including but not limited to data itself, data acquisition or usage) involved in the technical solutions of the present disclosure shall comply with provisions of relevant laws and regulations.

It can be understood that before the technical solution disclosed in each embodiment of the present disclosure is used, the user should be informed of the type, use scope, use scenario, and the like of the personal information involved in the present disclosure in an appropriate manner in accordance with relevant laws and regulations, and the user's authorization should be obtained. For example, when a user's active request is received, prompt information is sent to the user to explicitly prompt the user that the operation requested by the user will need to obtain and use the user's personal information. Therefore, the user can independently choose whether to provide personal information to software or hardware such as an electronic device, an application, a server, or a storage medium that executes the operation of the technical solution of the present disclosure based on the prompt information.

As an optional but non-limiting implementation, in response to receiving the user's active request, for example, the prompt information may be sent to the user in a pop-up window, and the prompt information may be presented in the pop-up window in text. In addition, the pop-up window may also carry a selection control for the user to select “agree” or “disagree” to provide personal information to the electronic device.

It can be understood that the above notification and user authorization obtaining process are only illustrative and do not limit the implementations of the present disclosure. Other methods that comply with relevant laws and regulations may also be applied to the implementations of the present disclosure.

It should be noted that concepts such as “first” and “second” mentioned in the present disclosure are only used to distinguish different apparatuses, modules, or units, and are not used to limit an order or interdependence of functions performed by these apparatuses, modules, or units.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

For purposes of the present disclosure, the phrase “A and/or B” means (A), (B), or (A and B).

Names of messages or information exchanged between a plurality of apparatuses in the embodiments of the present disclosure are used for illustrative purposes only, and are not used to limit the scope of these messages or information.

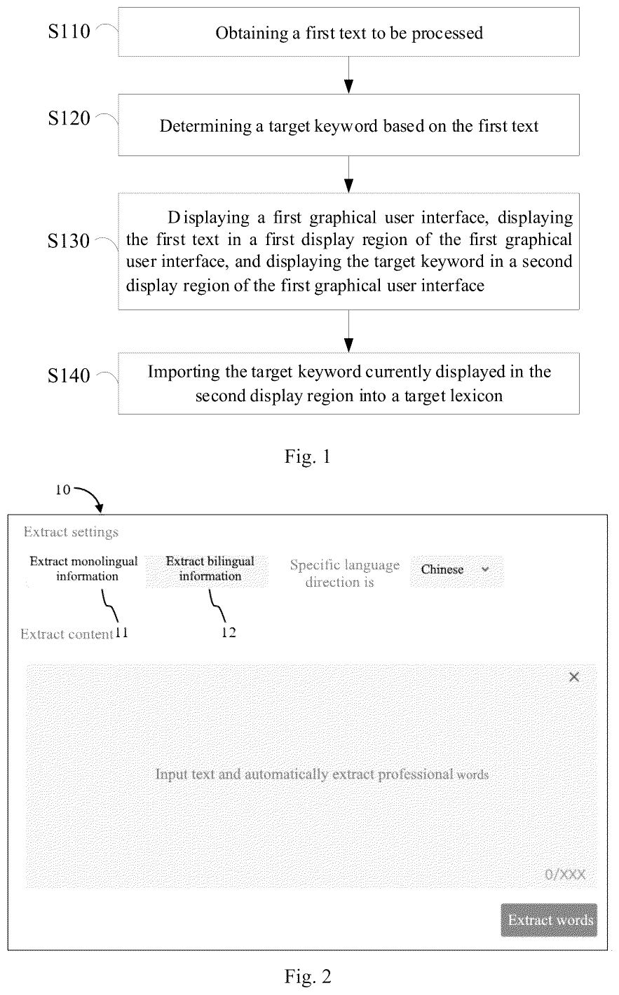

Referring to FIG. 1, which is a flowchart of a text processing method 100 according to an embodiment of the present disclosure. The method 100 includes step S110 to step S140.

Step S110: obtaining a first text to be processed.

In some embodiments, a text entered by a user in a preset text input box may be obtained, or a text content in a file (for example, a document or an image) uploaded by the user may be obtained, or a text content may be obtained based on an address specified by the user, for example, the text content in a related online document or web page is obtained based on a specified web link.

Step S120: determining a target keyword based on the first text.

In some embodiments, the target keyword may be determined based on a text keyword extraction method based on word frequency statistics, a Naive Bayes keyword extraction algorithm, a machine learning-based method, or a natural language processing-based method, but the present disclosure is not limited thereto.

In an actual application scenario, the target keyword may be a frequently-used word, a hot word, a professional term, a place name, a person name, an idiom, an article name, a poem name, or the like in a related field.

In some embodiments, the target keyword determined based on the first text may be an original word appearing in the first text or a synonym or near-synonym thereof.

Step S130: displaying a first graphical user interface, displaying the first text in a first display region of the first graphical user interface, and displaying the target keyword in a second display region of the first graphical user interface.

In this embodiment, as a display interface for a keyword determination result, the first display region of the first graphical user interface displays the extracted first text, and the second display region displays the extracted target keyword.

Step S140: importing the target keyword currently displayed in the second display region into a target lexicon.

In some embodiments, the target keyword currently displayed in the second display region may be imported into the target lexicon in response to an instruction of the user (for example, in response to a preset “confirm” control being triggered).

In some embodiments, the target lexicon may include a lexicon used for speech recognition. A speech recognition technology in combination with a specific lexicon can improve the accuracy of speech recognition, and in this embodiment, the lexicon can be updated in a personalized and efficient manner based on the input corpus.

In some embodiments, a candidate lexicon interface may be provided to the user, the candidate lexicon interface displays more than one candidate lexicon, and a target lexicon is determined in response to the user's selection of a candidate lexicon. In some embodiments, the candidate lexicon includes a lexicon in a language that is the same as that of the determined target keyword and that is associated with a currently logged-in account. In some embodiments, in the “bilingual extraction” mode mentioned below, a translation direction of the candidate lexicon (for example, the translation direction may be Chinese-English translation) is the same as a translation direction between the target keyword and a translation thereof.

According to one or more embodiments of the present disclosure, by obtaining a first text to be processed, determining a target keyword based on the first text, displaying the first text in a first display region of the first graphical user interface, displaying the target keyword in a second display region of the first graphical user interface, and importing the target keyword currently displayed in the second display region into a target lexicon, keywords in the corpus can be automatically extracted and imported into the target lexicon, so that the target lexicon can be updated in a personalized and efficient manner based on the corpus input by the user. In addition, the first text and the target keyword are displayed in the first and second display regions provided by the first graphical user interface for comparison, so that the user can perform comparison and subsequent operations.

In some embodiments, a translation corresponding to the target keyword may also be obtained, and the translation and the original text corresponding the translation are displayed in the second display region together.

In a specific implementation, a “monolingual extraction” mode and/or a “bilingual extraction” mode may be provided. In the “monolingual extraction” mode, only the target keyword in the first text is extracted (without providing a corresponding translation), and the extracted target keyword may be subsequently imported into a lexicon used for speech recognition. In the “bilingual extraction” mode, not only the target keyword in the first text is extracted, but also a translation corresponding to the target keyword is provided, and the target keyword and the translation corresponding to the target keyword may be subsequently imported into a lexicon for storing translation terminologies.

In some embodiments, the extraction mode to be adopted may be determined based on an instruction of the user. For example, with reference to FIG. 2, a first control 11 for performing “monolingual extraction” and a second control 12 for performing “bilingual extraction” may be provided to the user through a preset interface 10, and then the target keyword in the first text is extracted in response to the first control 11 being triggered, or the target keyword in the first text is extracted and the corresponding translation is obtained in response to the second control 12 being triggered. In some embodiments, a language (translation direction) used for the translation may be preset by the user.

In some embodiments, the target keyword may be highlighted in the first text displayed in the first display region. In this way, the user can easily know the position of the extracted target keyword in the original text and the context information of the target keyword.

In some embodiments, the target keyword may be highlighted by adjusting a font, a font size, a font color, a background color, or marking with an additional symbol.

In some embodiments, the step S130 includes: sequentially displaying target keywords in the second display region based on a positional relationship between the target keywords in the first text. For example, the target keywords in the second display region may be sorted based on a positional relationship thereof in an original text (that is, the first text), and when a target keyword appears a plurality of times in the original text, the target keyword is sorted based on a position at which the target keyword appears for the first time.

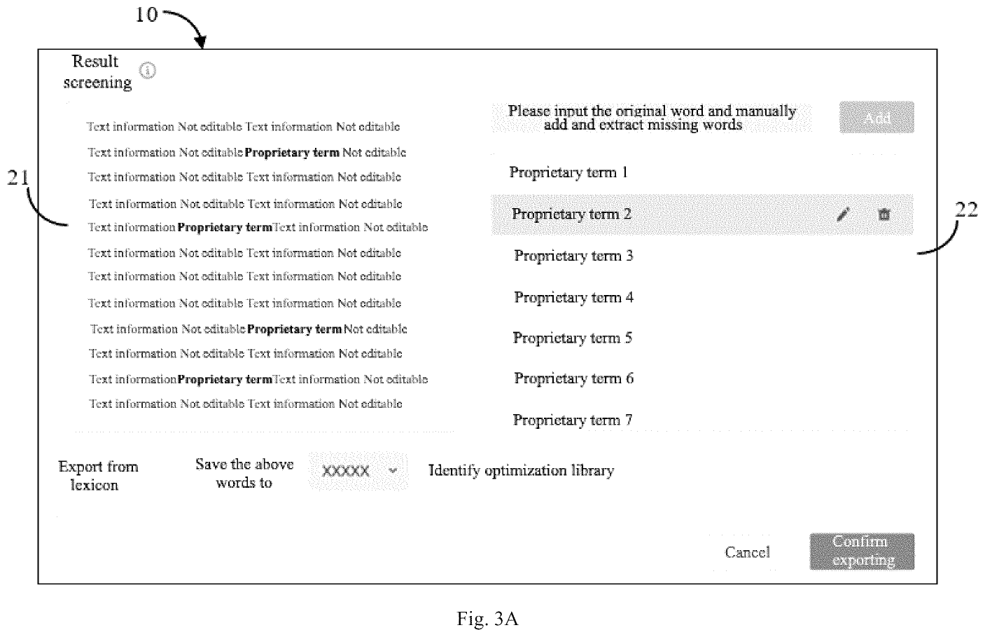

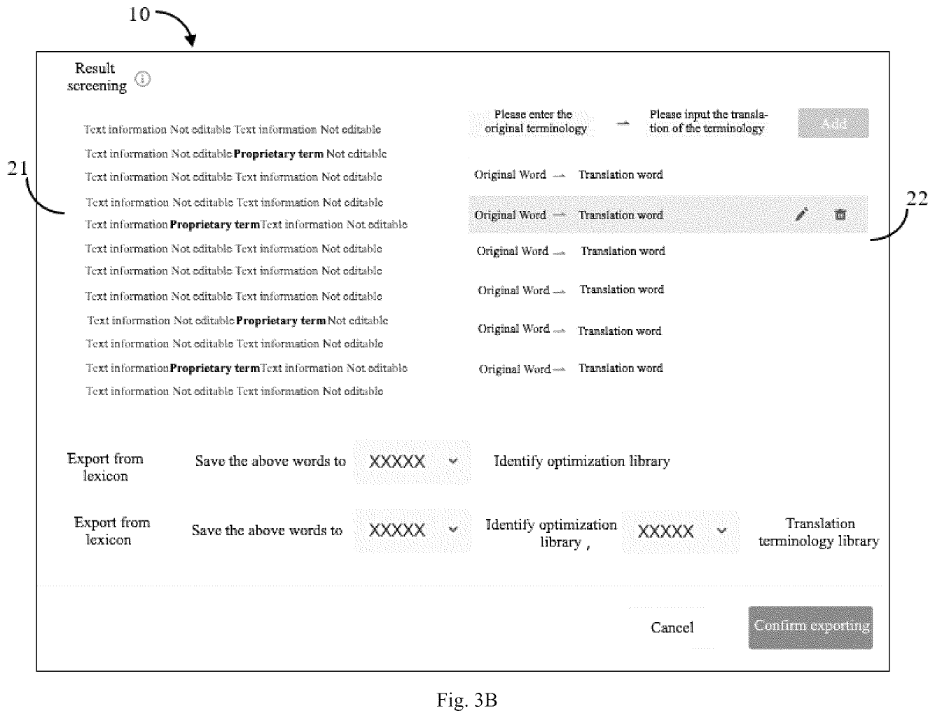

Referring to FIG. 3A and FIG. 3B, which are schematic diagrams of display styles of a first graphical user interface respectively in the “monolingual extraction” mode and the “bilingual extraction” mode according to an embodiment of the present disclosure. The first display region 21 of the first graphical user interface 20 displays the first text from which the target keyword is extracted, and the extracted target keyword is highlighted in the first text. The second display region 22 of the first graphical user interface 20 displays the determined target keyword (referring to FIG. 3A) or the target keyword and a translation thereof (referring to FIG. 3B).

In some embodiments, the target keyword displayed in the second display region may also be updated in response to an input of the user. For example, the user may modify or delete the target keyword or the translation thereof displayed in the second display region, or may add a target keyword that has not been extracted and a translation thereof.

In a specific implementation, when the target keyword actively added by the user is the same as the target keyword already displayed in the second display region, a preset prompt may be displayed, for example, “The word already exists, do not add it repeatedly”, but the present disclosure is not limited thereto.

In some embodiments, the step S120 includes:
step A1: constructing a target instruction for a target language model based on the first text; and
step A2: inputting the target instruction into the target language model to obtain the target keyword.

For example, the target language model may include a large language model, such as a Transformer-based model, an autoencoder-based model, a sequence-to-sequence model, a recurrent neural network model, or a hierarchical model, but the present disclosure is not limited thereto.

In a specific implementation, an instruction (for example, a prompt) for inputting to the target language model may be generated based on the first text and a preset first instruction, the preset first instruction may be “summarize and list keywords in the following text, types of the keywords include . . . ”, but the present disclosure is not limited thereto.

In some embodiments, the first instruction may be determined based on an instruction of the user when determining the target keyword based on the first text. For example, in response to the first control 11 being triggered, the first instruction is determined as an instruction for instructing the target language model to determine the target keyword based on the text; and in response to the second control 12 being triggered, the first instruction is determined as an instruction for instructing the target language model to determine the target keyword based on the text and to provide a translation in a specific language. For example, when the user triggers the first control 11, the first instruction may include “summarize and list keywords in the following text”; and when the user triggers the second control 12, the first instruction may be “summarize and list keywords in the following text and provide English translation(s) thereof”, but the present disclosure is not limited thereto.

After the first instruction is determined and the first text is obtained, the first instruction and the first text may be spliced to obtain the target instruction (for example, the prompt) for the target language model.

In some embodiments, the step A1 includes:
step a11: in response to a total number of characters in a current first text exceeding a first threshold N, determining a first target text based on a last target symbol in first N characters in the current first text, in which N is a positive integer; and
step a12: constructing an instruction for the target language model based on the first target text.

The language model may have a word number limit for an input text. In this regard, the first text may be segmented based on the word number limited by the model, and the segments are respectively input to the language model. However, mechanically segmenting the text based only on the word number may easily result in an incomplete segmented text paragraph, which in turn hinders the language model from understanding and further processing the instruction. In this embodiment, the first target text is further determined based on the last target symbol (that is, the target symbol closest to the Nth character) in the first N characters in the first text, so that the first target text with complete semantic content can be obtained, thereby ensuring that the target language model can summarize and list the target keywords based on the relatively complete text.

For example, the first target symbol may be a punctuation mark indicating that a relatively complete semantic sentence ends here, for example, a period, a semicolon, a back quote, or the like.

In a specific implementation, a specific value of the first threshold N may be determined based on a word number limit of the target language model. For example, the first threshold N may be equal to or less than the word number limit.

It can be understood that in an actual application scenario, when the number of remaining characters in the first text still exceeds the first threshold N after the first target text is divided out, steps a11 to 12 may be performed again until the number of characters in the current first text does not exceed the first threshold N.

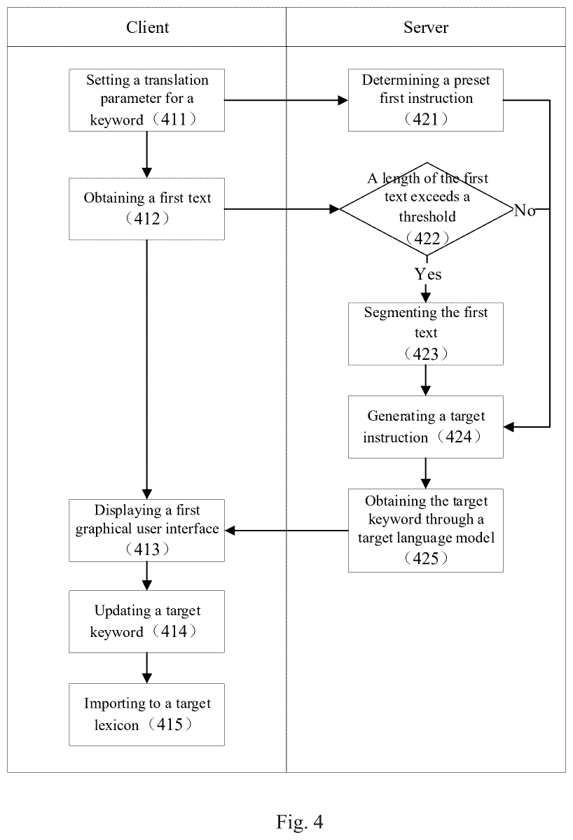

Referring to FIG. 4, which is a signal flow diagram of a text processing system according to an embodiment of the present disclosure. In step 411, a client may set a translation parameter for a keyword based on an input of a user. The translation parameter for the keyword is used to indicate whether to provide a translation of the target keyword and a language of the translation (when the translation is provided). In other words, the translation parameter for the keyword may be used to indicate that only the target keyword is determined from the text (for example, the “monolingual extraction” mode in the foregoing embodiment), or to indicate that the target keyword is determined from the text and a translation in a specific language is provided (for example, the “bilingual extraction” mode in the foregoing embodiment). Correspondingly, in step 421, a server can determine a preset first instruction for a target language model based on the translation parameter. For example, when the translation parameter indicates not to provide the translation (that is, indicates that only the target keyword is determined from the text), the determined first instruction may be “summarize and list keywords in the following text”; and when the translation parameter for the keyword indicates to provide a translation in a language X (that is, indicates that the target keyword is determined from the text and a translation in the specific language X is provided), the determined first instruction may be “summarize and list keywords in the following text and provide a translation in the language X”, but the present disclosure is not limited thereto.

In step 412, the client obtains the first text uploaded by the user. Correspondingly, in step 422, the server determines whether a length of the first text exceeds a preset limit. When the length of the first text exceeds the preset limit, the server segments the first text (that is, step 423).

In step 424, the server generates a target instruction based on the first text (or the segmented first text) and the first instruction. For example, the server may splice the first text and the first instruction to form a prompt for the target language model.

In step 425, the server inputs the target instruction into the target language model to obtain the target keyword, and returns the target keyword to the client. Correspondingly, in step 413, the client may display a first graphical user interface, in which the first text is displayed in a first display region of the first graphical user interface, and the target keyword (or the target keyword and a translation thereof) is displayed in a second display region of the first graphical user interface.

In step 414, the client can update the target keyword in response to an input of the user. For example, the user may edit the target keyword (and the translation thereof) displayed on the first graphical user interface, for example, modify, delete a target keyword, or add a new target keyword.

In step 415, the client can import the (updated) target keyword into the target lexicon.

It should be noted that in other embodiments, some or all of steps 421 to 425 performed by the server may alternatively be performed by the client. For example, the client performs steps such as determining the first instruction, segmenting the first text, and obtaining the target keyword, but the present disclosure is not limited thereto.

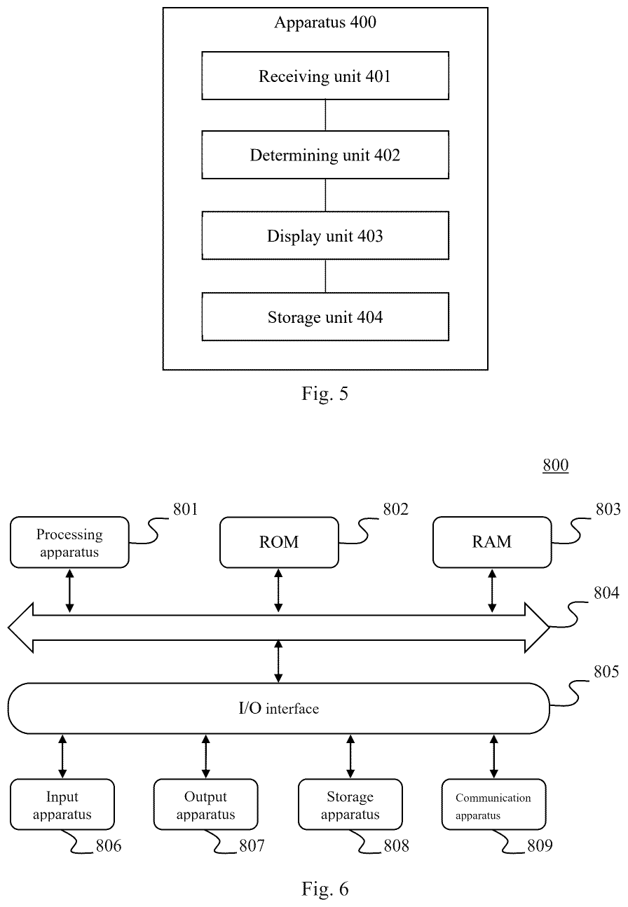

Referring to FIG. 5, which is a schematic diagram of a text processing apparatus 400 according to an embodiment of the present disclosure. The apparatus 400 includes:
a receiving unit 401, configured to obtain a first text to be processed;
a determining unit 402, configured to determine a target keyword based on the first text;
a display unit 403, configured to display a first graphical user interface, display the first text in a first display region of the first graphical user interface, and display the target keyword in a second display region of the first graphical user interface; and
a storage unit 403, configured to import the target keyword currently displayed in the second display region into a target lexicon.

In some embodiments, the target keyword is highlighted in the first text displayed in the first display region.

In some embodiments, the text processing apparatus further includes:
a translation unit, configured to obtain a translation corresponding to the target keyword; and
the display unit is configured to display the target keyword and the translation corresponding to the target keyword in the second display region.

In some embodiments, the storage unit is configured to store the target keyword currently displayed in the second display region into a first lexicon, and/or store the target keyword currently displayed in the second display region and the translation corresponding to the target keyword into a second lexicon;
the first lexicon includes a lexicon used for speech recognition; and the second lexicon includes a lexicon used for storing translation terminologies.

In some embodiments, the display unit is configured to sequentially display target keywords in the second display region based on a positional relationship between the target keywords in the first text.

In some embodiments, the text processing apparatus further includes:
an updating unit, configured to update the target keyword displayed in the second display region in
response to an input of a user.

In some embodiments, the determining unit includes:
an instruction construction sub-unit, configured to construct a target instruction for a target language model based on the first text; and
a keyword obtaining sub-unit, configured to input the target instruction into the target language model to obtain the target keyword.

In some embodiments, the instruction construction subunit is configured to, in response to a total number of characters in a current first text exceeds a first threshold N, determine a first target text based on a last target symbol in first N characters in the current first text, and construct an instruction for the target language model based on the first target text, in which N is a positive integer.

For the embodiments of the apparatus, because the embodiments basically correspond to the method embodiments, the relevant parts can be referred to the description of the method embodiments. The apparatus embodiments described above are merely illustrative, and the modules or units described as separate parts may or may not be physically separated. Some or all of the modules or units may be selected according to actual needs to achieve the objectives of the solutions of the embodiments. Those of ordinary skill in the art can understand and implement the embodiments of the present disclosure without creative efforts.

Accordingly, according to one or more embodiments of the present disclosure, an electronic device is provided, the device includes:
at least one memory and at least one processor;
the memory is configured to store a program code, and the processor is configured to call the program code stored in the memory to enable the electronic device to perform the text processing method according to one or more embodiments of the present disclosure.

Accordingly, according to one or more embodiments of the present disclosure, a non-transitory computer storage medium is provided, the non-transitory computer storage medium stores a program code, when the program code is executed by a computer device, the computer device is caused to perform the text processing method according to one or more embodiments of the present disclosure.

Referring to FIG. 6, FIG. 6 illustrates a structural schematic diagram of an electronic device 800 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 6 is merely an example, and should not pose any limitation to the functions and the range of use of the embodiments of the present disclosure.

As illustrated in FIG. 6, the electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 508 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 6 illustrates the electronic device 800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. When the computer program is executed by the processing apparatus 801, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the method of the embodiments of the present disclosure.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, a text processing method is provided, the method includes: obtaining a first text to be processed; determining a target keyword based on the first text; displaying a first graphical user interface, in which the first text is displayed in a first display region of the first graphical user interface, and the target keyword is displayed in a second display region of the first graphical user interface; and importing the target keyword currently displayed in the second display region into a target lexicon.

According to one or more embodiments of the present disclosure, the target keyword is highlighted in the first text displayed in the first display region.

According to one or more embodiments of the present disclosure, the method further includes: obtaining a translation corresponding to the target keyword; and the displaying the target keyword in the second display region of the first graphical user interface includes: displaying the target keyword and the translation corresponding to the target keyword in the second display region.

According to one or more embodiments of the present disclosure, the importing the target keyword currently displayed in the second display region into a target lexicon includes: storing the target keyword currently displayed in the second display region into a first lexicon; and/or storing the target keyword currently displayed in the second display region and the translation corresponding to the target keyword into a second lexicon; in which the first lexicon includes a lexicon used for speech recognition; and the second lexicon includes a lexicon used for storing translation terminologies.

According to one or more embodiments of the present disclosure, the displaying the target keyword in the second display region of the first graphical user interface includes: sequentially displaying target keywords in the second display region based on a positional relationship between the target keywords in the first text.

According to one or more embodiments of the present disclosure, the method further includes: updating the target keyword displayed in the second display region in response to an input of a user.

According to one or more embodiments of the present disclosure, the determining a target keyword based on the first text includes: constructing a target instruction for a target language model based on the first text; and inputting the target instruction into the target language model to obtain the target keyword.

According to one or more embodiments of the present disclosure, the constructing a target instruction for a target language model based on the first text includes: in response to the number of characters in a current first text exceeding a first threshold N, determining a first target text based on a last target symbol in first N characters in the current first text, in which N is a positive integer; and constructing an instruction for the target language model based on the first target text.

According to one or more embodiments of the present disclosure, a text processing apparatus is provided, the apparatus includes: a receiving unit, configured to obtain a first text to be processed; a determining unit, configured to determine a target keyword based on the first text; a display unit, configured to display a first graphical user interface, in which the first text is displayed in a first display region of the first graphical user interface, and the target keyword is displayed in a second display region of the first graphical user interface; and a storage unit, configured to import the target keyword currently displayed in the second display region into a target lexicon.

According to one or more embodiments of the present disclosure, an electronic device is provided, the device includes: at least one memory and at least one processor; the memory is configured to store a program code, and the processor is configured to call the program code stored in the memory to enable the electronic device to perform the text processing method according to one or more embodiments of the present disclosure.

According to one or more embodiments of the present disclosure, a non-transitory computer storage medium is provided, the medium stores a program code, when the program code is executed by a computer device, the computer device is caused to perform the text processing method according to one or more embodiments of the present disclosure.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. A text processing method, comprising:
obtaining a first text to be processed;
determining a target keyword based on the first text;
displaying a first graphical user interface, displaying the first text in a first display region of the first graphical user interface, and displaying the target keyword in a second display region of the first graphical user interface; and
importing the target keyword currently displayed in the second display region into a target lexicon.

2. The method according to claim 1, wherein the target keyword is highlighted in the first text displayed in the first display region.

3. The method according to claim 1, further comprising:
obtaining a translation corresponding to the target keyword; and
the displaying the target keyword in the second display region of the first graphical user interface comprises: displaying the target keyword and the translation corresponding to the target keyword in the second display region.

4. The method according to claim 3, wherein the importing the target keyword currently displayed in the second display region into a target lexicon comprises:
storing the target keyword currently displayed in the second display region into a first lexicon; and/or
storing the target keyword currently displayed in the second display region and the translation corresponding to the target keyword into a second lexicon;
wherein the first lexicon comprises a lexicon used for speech recognition; and the second lexicon comprises a lexicon used for storing translation terminologies.

5. The method according to claim 1, wherein the displaying the target keyword in the second display region of the first graphical user interface comprises:
sequentially displaying target keywords in the second display region based on a positional relationship between the target keywords in the first text.

6. The method according to claim 1, further comprising:
updating the target keyword displayed in the second display region in response to an input of a user.

7. The method according to claim 1, wherein the determining a target keyword based on the first text comprises:
constructing a target instruction for a target language model based on the first text; and
inputting the target instruction into the target language model to obtain the target keyword.

8. The method according to claim 7, wherein the constructing a target instruction for a target language model based on the first text comprises:
in response to a total number of characters in a current first text exceeding a first threshold N, determining a first target text based on a last target symbol in first N characters in the current first text, wherein N is a positive integer; and
constructing an instruction for the target language model based on the first target text.

9. An electronic device, comprising:
at least one memory and at least one processor;
wherein the at least one memory is configured to store a program code, and the at least one processor is configured to call the program code stored in the memory to enable the electronic device to:
obtain a first text to be processed;
determine a target keyword based on the first text;
display a first graphical user interface, display the first text in a first display region of the first graphical user interface, and display the target keyword in a second display region of the first graphical user interface; and
import the target keyword currently displayed in the second display region into a target lexicon.

10. A non-transitory computer storage medium, storing a program code,
wherein when the program code is executed by a computer device, the computer device is caused to:
obtain a first text to be processed;
determine a target keyword based on the first text;
display a first graphical user interface, display the first text in a first display region of the first graphical user interface, and display the target keyword in a second display region of the first graphical user interface; and
import the target keyword currently displayed in the second display region into a target lexicon.

11. The electronic device according to claim 9, wherein the target keyword is highlighted in the first text displayed in the first display region.

12. The electronic device according to claim 9, wherein the electronic device is further enabled to:
obtain a translation corresponding to the target keyword; and
displaying the target keyword and the translation corresponding to the target keyword in the second display region.

13. The electronic device according to claim 12, wherein the electronic device is further enabled to:
store the target keyword currently displayed in the second display region into a first lexicon; and/or
store the target keyword currently displayed in the second display region and the translation corresponding to the target keyword into a second lexicon;
wherein the first lexicon comprises a lexicon used for speech recognition; and the second lexicon comprises a lexicon used for storing translation terminologies.

14. The electronic device according to claim 9, wherein the electronic device is further enabled to:
sequentially display target keywords in the second display region based on a positional relationship between the target keywords in the first text.

15. The electronic device according to claim 9, wherein the electronic device is further enabled to:
update the target keyword displayed in the second display region in response to an input of a user.

16. The electronic device according to claim 9, wherein the electronic device is further enabled to:
construct a target instruction for a target language model based on the first text; and
input the target instruction into the target language model to obtain the target keyword.

17. The electronic device according to claim 16, wherein the electronic device is further enabled to:
in response to a total number of characters in a current first text exceeding a first threshold N, determine a first target text based on a last target symbol in first N characters in the current first text, wherein N is a positive integer; and
construct an instruction for the target language model based on the first target text.
